(19) United States
(12) Patent Application Publication
(10) Pub. No.: US 2020/0407200 A1
(43) Pub. Date: Dec. 31, 2020

(54) CRAWLER-TYPE CRANE

(71) Applicant: SUMITOMO HEAVY INDUSTRIES CONSTRUCTION CRANES CO., LTD., Tokyo (JP)

(72) Inventor: Takumi Okubo, Aichi (JP)

(21) Appl. No.: 17/015,861

(22) Filed: Sep. 9, 2020

Related U.S. Application Data
(63) Continuation of application No. PCT/JP2019/010227, filed on Mar. 13, 2019.

(30) Foreign Application Priority Data
Mar. 13, 2018 (JP) 2018-045722

(51) Int. Cl. B66C 23/74; B66C 23/36; B66C 13/16; B62D 55/06; B66C 9/14

(52) U.S. Cl. CPC B66C 23/74; B66C 23/36; B66C 9/14; B62D 55/06; B66C 13/16

(57) ABSTRACT

A crawler-type crane includes an upper turning body and a lower traveling body on which the upper turning body is turnably mounted and which has a pair of left and right side frames; a car body that connects both the side frames to each other to support the upper turning body; and a front lower weight and a rear lower weight attached to both front and rear end sides of the car body. Rotational moments with reference to the center position of the upper turning body of the front lower weight and the rear lower weight are made different from each other.

### RELATED APPLICATIONS

The contents of Japanese Patent Application No. 2018-045722, and of International Patent Application No. PCT/JP2019/010227, on the basis of each of which priority benefits are claimed in an accompanying application data sheet, are in their entirety incorporated herein by reference.

### BACKGROUND

### Technical Field

A certain embodiment of the present invention relates to a crawler-type crane in which an upper turning body is turnably mounted on a lower traveling body.

### Description of Related Art

In crawler-type cranes, an upper turning body is turnably mounted above a lower traveling body including a crawler, a boom is supported on a front side of the upper turning body so as to be capable of being derricked, and a counterweight is provided on a rear side of the upper turning body. Additionally, the lower traveling body has a pair of left and right crawler frames with crawlers mounted on outer peripheries thereof, and a car body that connects the crawler frames to each other to support the upper turning body. In order to improve the balance performance of the entire crawler-type cranes, a pair of lower weights (also referred to as car body weights) are attached to both front and rear end sides of the car body.

In such crawler-type cranes, there is suggested a technique of movably supporting at least one of the pair of lower weights with a support mechanism including a link member and the like and operating a drive unit including a hydraulic cylinder to move the lower weight in a front-rear direction, thereby making the centroid position of the lower traveling body movable (refer to the related art).

In the crawler-type crane described in the related art, during normal work, the pair of lower weights is fixedly attached to both front and rear end sides of the car body, and in a case where the boom is raised by itself during assembly, the drive unit is operated to move the front lower weight supported by the support mechanism forward. Accordingly, since the front lower weight moves to the grounding position where the front lower weight is in contact with the ground, the centroid position of the lower traveling body can be changed rearward of the turning center of the upper turning body to prevent the crawler-type crane from being tumbled forward.

### SUMMARY

According to an embodiment of the present invention, there is provided a crawler-type crane including an upper turning body and a lower traveling body on which the upper turning body is turnably mounted and which has a pair of left and right side frames, a car body that connects both the side frames to each other to support the upper turning body, and a front lower weight and a rear lower weight attached to both front and rear end sides of the car body. Here, rotational moments with reference to the center position of the upper turning body of the front lower weight and the rear lower weight are made different from each other.

### BRIEF DESCRIPTION OF THE DRAWINGS

FIG. 1 is a side view of a crawler-type crane according to an embodiment of the invention.

FIG. 2 is a plan view of a lower traveling body provided in the crawler-type crane illustrated in FIG. 1.

FIG. 3 is a front view of the lower traveling body included in the crawler-type crane of FIG. 1.

FIG. 4 is a sectional view taken along line IV-IV in FIG. 2.

FIG. 5 is a side view illustrating a connection state of a front lower weight attached to a car body of the lower traveling body.

FIG. 6 is a perspective view illustrating an attachment mechanism for the car body and the front lower weight.

FIG. 7 is a detailed view of portion VII of FIG. 6.

FIG. 8 is a perspective view illustrating an attachment mechanism for the car body and a rear lower weight.

FIG. 9 is a detailed view of portion IX in FIG. 8.

FIG. 10 is a perspective view illustrating an attachment portion of the car body and a jack.

FIG. 11 is an explanatory view of main parts of a crawler-type crane according to Modification Example 1.

FIG. 12 is a side view of a side frame of the crawler-type crane according to Modification Example 2.

FIG. 13 is a side view of the side frame of the crawler-type crane according to Modification Example 3.

FIG. 14 is a side view illustrating the lower weights of the crawler crane according to Modification Example 4.

FIG. 15 is a side view illustrating the lower weights of the crawler crane according to Modification Example 5.

FIG. 16 is a side view illustrating the lower weights of the crawler crane according to Modification Example 6.

FIG. 17 is a side view illustrating the lower weights of the crawler crane according to Modification Example 7.

FIG. 18 is a side view of the car body of the crawler crane according to Modification Example 8.

FIG. 19 is a schematic diagram around an attachment portion and a jack arm according to Modification Example 9.

FIG. 20 is a schematic diagram around the attachment portion and the jack arm according to Modification Example 10.

FIG. 21 is a schematic diagram around the attachment portion and the jack arm according to Modification Example 11.

FIG. 22 is a diagram illustrating the jack arm and the lower weights according to Modification Example 12.

FIG. 23 is a diagram illustrating the jack arm and the front lower weight according to Modification Example 13.

### DETAILED DESCRIPTION

In the crawler-type crane, an idler and a traveling device are installed at both end portions of a side frame in the front-rear direction, and a crawler is mounted on outer peripheries of the idler and the traveling device. Therefore, the center of gravity of the lower traveling body does not become the center position of the side frame in the front-rear direction and is biased toward a rear end side where the traveling device including heavy materials such as a drive motor and a speed reducer is disposed. Meanwhile, with regard to the upper turning body mounted on the car body of the lower traveling body, the turning center of the upper turning body coincides with the turning center of the car body. Therefore, the turning center of the upper turning body and the center of gravity of the lower traveling body positionally deviate from each other in the front-rear direction.

Accordingly, during forward lifting in which work is performed in a state where an operator's cab provided on a front side of the upper turning body is oriented to the front of the lower traveling body (a side where the idler is disposed), and during backward lifting in which work is performed in a state where the upper turning body is turned 180 degrees to orient the operator's cab to the rear side of the lower traveling body (a side where the traveling device is disposed), the centroid position of the entire crawler-type crane changes largely. That is, since the distance between the turning center of the upper turning body and the centroid position of the entire crawler-type crane during the forward lifting is larger than that during the backward lifting, the backward stability becomes significantly worse during the forward lifting.

In addition, in the related art, the normal work is performed in a state where the pair of lower weights are fixedly attached to both front and rear end sides of the car body. However, in a case where the drive unit is operated to move the attachment position of the lower weight also during the normal work, the centroid position of the lower traveling body can be moved. However, in that case, since it is necessary to operate the drive unit to change the attachment position of the lower weight every time the upper turning body is turned, work efficiency deteriorates significantly. Additionally, the configuration including the drive unit and the support mechanism becomes also complicated. Ina case where the drive unit fails for some reason, the lower weight cannot be moved. Therefore, it does not comply with the standard of the backward stability stipulated by the law in order to avoid backward tumbling.

The embodiment of the invention has been made in view of the above circumstances, and it is desirable to provide a crawler-type crane capable of ensuring high backward stability during both forward lifting and backward lifting.

According to the crawler-type crane of the embodiment of the invention, high backward stability can be ensured during both forward lifting and backward lifting. In addition, the problems, configurations, and effects other than the above-described ones will be apparent by the following description of the embodiments.

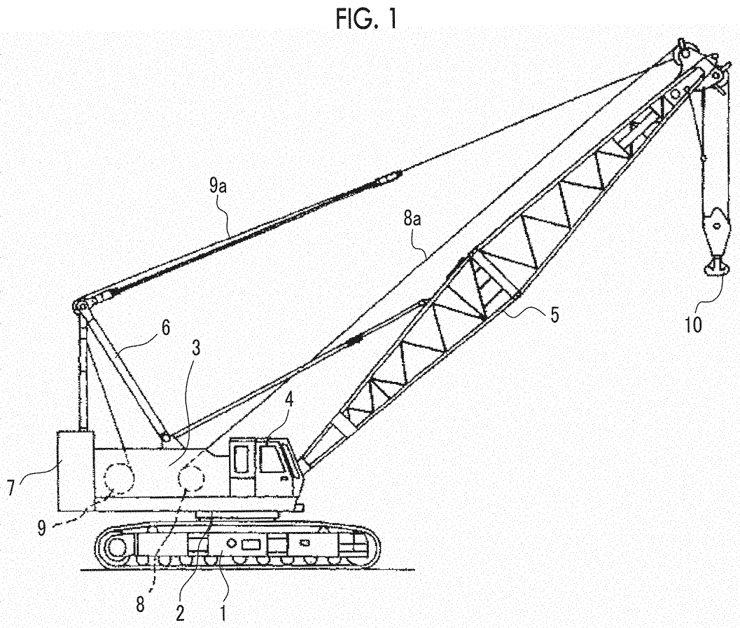

Hereinafter, a crawler-type crane according to an embodiment of the invention will be described with reference to the drawings. FIG. 1 is a side view illustrating the overall configuration of the crawler-type crane according to the present embodiment. As illustrated in FIG. 1, the crawler-type crane includes a lower traveling body 1 and an upper turning body 3 turnably mounted on the lower traveling body 1 via a turning ring 2, and the turning ring 2 is driven by a turning hydraulic motor (not illustrated).

A cab 4 that constitutes an operator's cab is provided on a front side of the upper turning body 3, and a base end portion of a boom 5 is pivotably supported. Additionally, a base end portion of a mast 6 is pivotably supported at a central portion of the upper turning body 3, and a counterweight 7 is provided on a rear side of the upper turning body 3.

A hoisting drum 8 and a derricking drum 9 are mounted on the upper turning body 3, and the hoisting drum 8 and the derricking drum 9 are respectively driven by hydraulic motors (neither illustrated). A hoisting rope 8a is wound around the hoisting drum 8, and when the hoisting drum 8 is pivoted by the driving of a turning hydraulic motor (not illustrated), the hoisting rope 8a is wound up or unwound and the hook 10 is raised and lowered. A derricking rope 9a is wound around the derricking drum 9, and when the derricking drum 9 is pivoted by the driving of a derricking hydraulic motor (not illustrated), the derricking rope 9a is wound up or unwound and the boom 5 is derricked.

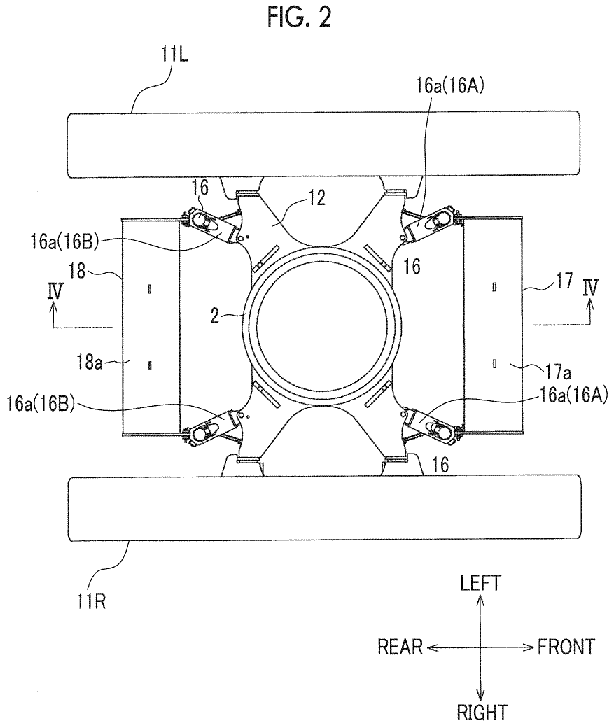

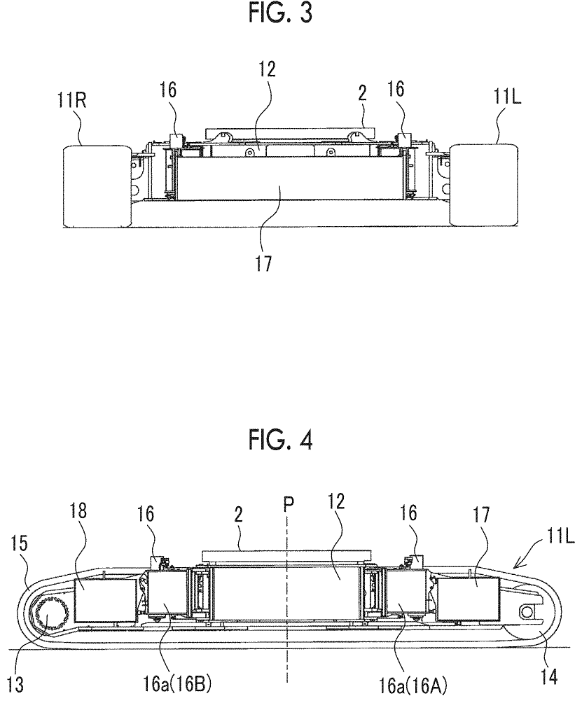

As illustrated in FIGS. 2 to 4, the lower traveling body 1 includes a pair of left and right side frames 11L and 11R extending in a front-rear direction, and a car body 12 connecting both the side frames 11L and 11R to each other, and the upper turning body 3 is supported by the car body 12 via the turning ring 2. A traveling device 13 including a drive motor and a speed reducer is disposed on one end side of each of the side frames 11L and 11R in the front-rear direction, an idler 14 is disposed on the other end side, and a crawler 15 is mounted on outer peripheries of the traveling device 13 and the idler 14. In the following description, a side where the idler 14 is disposed is the front side, and a side where the traveling device 13 is disposed is the rear side.

Abase portion of a jack arm 16a having a jack 16 mounted on a tip thereof is pivotably attached to each of a total of four points on both front surface end portions and both rear surface end portions of the car body 12. Each of the jacks 16 is for lifting and supporting the car body 12 when the crawler-type crane is assembled/disassembled and transported. In addition, in the following description, two front jack arms are denoted by reference signs 16A and are referred to as front jack arms, and two rear jack arms are denoted by reference signs 16B and referred to as rear jack arms.

A front lower weight 17 is attached to front jack arms 16A mounted on two front points of the car body 12, and a rear lower weight 18 is attached to rear jack arms 16B mounted on two rear points of the car body 12. The outer sizes of the front lower weight 17 and the rear lower weight 18 are substantially the same, but the masses of both are largely different from each other.

Specifically, although both a frame body 17a forming an outer shell of the front lower weight 17 and a frame body 18a forming an outer shell of the rear lower weight 18 have rectangular parallelepiped shapes having the same outer size, there is a large difference between the masses of filling materials to be filled into both, and a filling material with which the inside of the frame body 17a of the front lower weight 17 is filled is set to have a much larger mass than a filling material within the frame body 18a of the rear lower weight 18. In order to change the mass of the filling material within each of the frame bodies 17a and 18a, for example, the content of a heavy material (iron scrap or the like) having a large specific gravity with respect to concrete that is a filling material may be changed, or the volume of an internal space in which a filling material is stored may be changed in each of the frame bodies 17a and 18a.

The amount of difference in weight (mass) between the front lower weight 17 and the rear lower weight 18 needs to be set in consideration of the amount of deviation between the centroid position of the lower traveling body 1 and the turning center of the upper turning body 3. That is, since the upper turning body 3 is supported via the turning ring 2 on the car body 12 provided at a central portion of the lower traveling body 1, the turning center of the upper turning body 3 is the center position of the turning ring 2 on the car body 12 (refer to a straight line P illustrated in FIG. 4). In contrast, the center of gravity of the lower traveling body 1 does not become the center position of each of the side frames 11L and 11R in the front-rear direction, and is biased to a rear end side on which the traveling device 13 including heavy materials such as a drive motor and a speed reducer is disposed. Therefore, in a case where the front lower weight 17 attached to the front end side of the car body 12, out of the front lower weight 17 and the rear lower weight 18 mounted equidistantly from the turning center of the upper turning body 3, is made heavier than the rear lower weight 18 mounted on the rear end side of the car body 12 in order to cancel this bias amount, the centroid position of the lower traveling body 1 can be made to substantially coincide with the turning center of the upper turning body 3. In other words, as compared to a case where the weight of the front lower weight 17 and the weight of the rear lower weight 18 are the same, the centroid position of the lower traveling body 1 can be brought closer to the turning center of the upper turning body 3. In addition, in the present embodiment, the distance from the turning center of the upper turning body 3 to the center of gravity of the front lower weight 17 and the distance from the turning center of the upper turning body 3 to the center of gravity of the rear lower weight 18 are set to be the same. However, the embodiment of the invention is not limited to this, and both may be set to be different from each other.

Here, making the weights of the front lower weight 17 and the rear lower weight 18 different from each other means that the weights of both are different from each other, and (although the weights of both are designed to be the same) does not include different ones within the range of variations due to a manufacturing error. In the case of the present embodiment, since the weight is adjusted while packing a filling material into the frame body 17a of the front lower weight 17 and the frame body 18a of the rear lower weight 18, the manufacturing error is as small as about ±1%, and a variation of less than ±1% is allowed. Additionally, it is also possible to manufacture the front lower weight 17 and the rear lower weight 18 by casting. In that case, since the manufacturing error is as slightly large as about ±3%, a variation of less than ±3% is allowed. That is, a configuration in which the weights of the front lower weight 17 and the rear lower weight 18 according to the embodiment of the invention are made different from each other does not include a case in which (although the weights of both are designed to be the same) the weights of both are different from each other within a range of variation due to a manufacturing error. However, for example, a case where the weight of a lower weight having a larger difference between the weights of both is 4% or more is included in the configuration in which “the weights of the front lower weight 17 and the rear lower weight 18 are made different from each other”. In addition, in the present embodiment, the front lower weight 17 is set to be about 10% heavier than the rear lower weight 18.

The front lower weight 17 and the rear lower weight 18 having different weights in this way are connected to each other and are respectively attached to the front jack arm 16A and the rear jack arm 16B of the jack 16 via attachment mechanisms having mutually different connection forms in order to prevent erroneous attachment to the front end side and the rear end side of the car body 12 as described below.

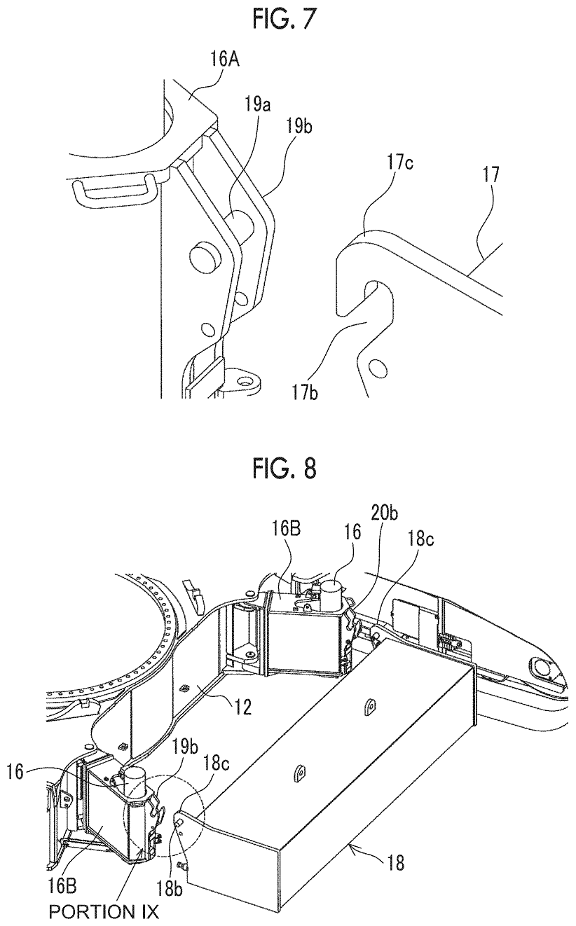

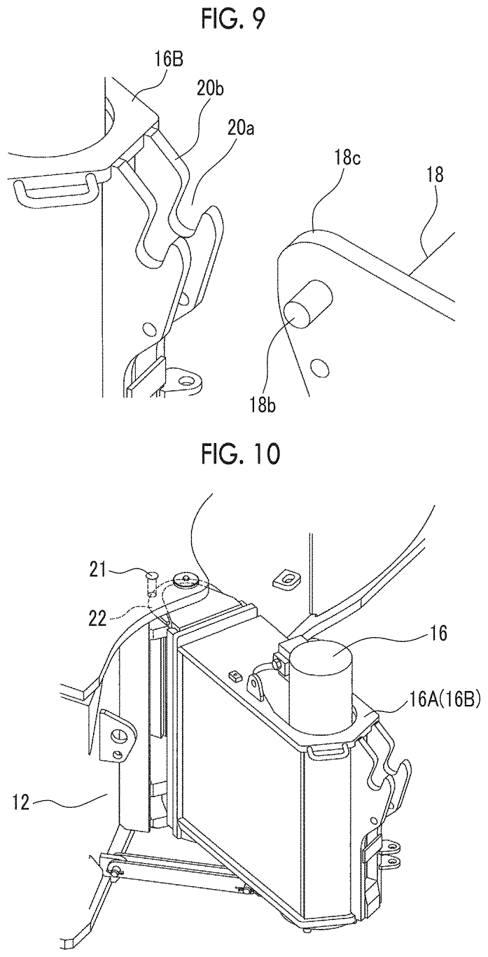

As illustrated in FIGS. 6 to 9, hook-shaped attachment portions (weight-side hooks) 17c having locking grooves 17b are formed so as to protrude obliquely upward from both side surfaces of the frame body 17a of the front lower weight 17 that face each other, and attachment portions 18c having pins (weight-side pins) 18b are formed so as to protrude obliquely upward from both side surfaces of the frame body 18a of the rear lower weight 18 that face each other. Meanwhile, attachment receiving portions 19b having a pin (body-side pins) 19a are formed at tip portions of the front jack arms 16A mounted on two front points of the car body 12, and hook-shaped attachment receiving portions (body-side hooks) 20b having locking grooves 20a are formed at tip portions of the rear jack arms 16B mounted on the two rear points of the car body 12.

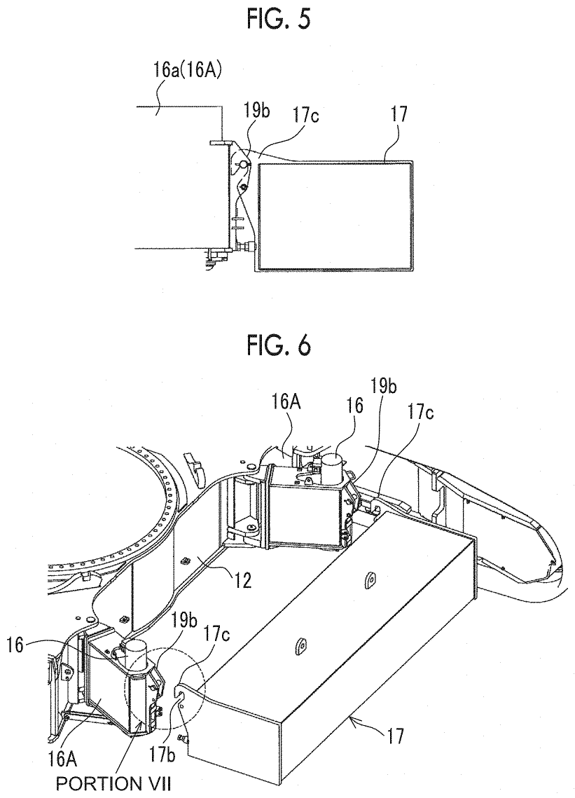

Therefore, by hooking the hook-shaped attachment portion 17c of the front lower weight 17 to the pin 19a provided on the attachment receiving portion 19b of the front jack arm 16A, the front lower weight 17 can be correctly attached to the front jack arm 16A (refer to FIG. 5). However, since both the attachment portions 17c of the front lower weight 17 and the attachment receiving portion 20b of the rear jack arm 16B are hook-shaped, the attachment portion 17c of the front lower weight 17 cannot be hooked on the attachment receiving portion 20b of the rear jack arm 16B, and the front lower weight 17 is prevented from being erroneously attached to the rear jack arm 16B.

The same applies to the rear lower weight 18, and a pin 18b provided on the attachment portion 18c of the rear lower weight 18 is hooked on the hook-shaped attachment receiving portion 20b of the rear jack arm 16B, so that it is possible to correctly attach the rear lower weight 18 to the rear jack arm 16B. However, since the attachment portion 18c of the rear lower weight 18 cannot be hooked on the attachment portion 20b of the rear jack arm 16B, the rear lower weight 18 can be prevented from being erroneously attached to the front jack arm 16A.

In addition, the relationship between the pin and the hook may be the reverse to the above, and a pin may be provided on an attachment portion of the front lower weight 17 such that the attachment receiving portion of the front jack arm 16A is hook-shaped and an attachment portion of the rear lower weight 18 may be hook-shaped such that it is also possible to provide a pin on the attachment receiving portion of the rear jack arm 16B.

Additionally, as the attachment mechanisms for attaching the front lower weight 17 and the rear lower weight 18 to the car body 12, it is possible to adopt a configuration other than the above-described pin and hook. In short, any attachment mechanisms capable of mechanically preventing the erroneous attachment between the front lower weight 17 and the rear lower weight 18 having different weights may be used.

Moreover, in order to visually prevent the erroneous attachment of the front lower weight 17 and the rear lower weight 18, the frame bodies 17a and 18a may be displayed or colored in different display forms, such visual error prevention means may be used independently, or may be used in combination with the above-described attachment mechanisms having different connection forms.

Here, in a case where the front lower weight 17 and the rear lower weight 18 are attached to the car body 12 via the front jack arm 16A and the rear jack arm 16B of the jack 16, it is necessary to attach the front jack arm 16A and the rear jack arm 16B to the car body 12 at a predetermined position without mistake. FIG. 10 is an explanatory view illustrating a configuration example for preventing such an erroneous attachment of the jack 16.

As illustrated in FIG. 10, a first engagement pin 21 that is a blocking member is provided at a connection position on the front surface side of the car body 12, a second engagement pin (not illustrated) that is a blocking member is provided at a connection position on the rear surface side of the car body 12, and the first engagement pin 21 and the second engagement pin have different installation positions at the respective connection positions thereof. Additionally, abutment portions 22 are provided on base end sides of the front jack arm 16A and the rear jack arm 16B, respectively, and the abutment portion 22 of the front jack arm 16A is capable of abutting only against the second engagement pin, and the abutment portion 22 of the rear jack arm 16B is capable of abutting only against the first engagement pin 21.

In such a configuration, when the base end side of the front jack arm 16A is inserted into the front surface side of the car body 12 provided with the first engagement pin 21, the abutment of the abutment portion 22 of the front jack arm 16A against the first engagement pin 21 is avoided. Therefore, the front jack arm 16A can be correctly attached to the front surface side of the car body 12. However, when the base end side of the front jack arm 16A is inserted into the rear end side of the car body 12 provided with the second engagement pin, the abutment portion 22 of the front jack arm 16A abuts against (interferes with) the second engagement pin during the insertion. Therefore, the front jack arm 16A cannot be attached to the rear end side of the car body 12.

The same applies to the rear jack arm 16B. When the base end side of the rear jack arm 16B is inserted into the rear end side of the car body 12 provided with the second engagement pin, the abutment of the abutment portion 22 of the rear jack arm 16B against the second engagement pin is avoided. Therefore, the rear jack arm 16B can be correctly attached to the rear surface side of the car body 12. However, when the base end side of the rear jack arm 16B is inserted into the front surface side of the car body 12 provided with the first engagement pin 21, the abutment portion 22 of the rear jack arm 16B abuts against (interferes with) the first engagement pin 21 during the insertion. Therefore, the rear jack arm 16B cannot be attached to the front end side of the car body 12.

In addition, configurations different from such blocking members (the first engagement pin 21 and the second engagement pin), and the abutment portion 22 can be used to prevent an erroneous attachment of the front jack arm 16A and the rear jack arm 16B. In short, a first blocking member that allows the attachment of the front jack arm 16A to block the attachment of the rear jack arm 16B may be provided at the connection position on the front end side of the car body 12, and a second blocking member that blocks the attachment of the front jack arm 16A to allow the attachment of the rear jack arm 16B may be provided on the rear end side of the car body 12.

Additionally, in the configuration example illustrated in FIG. 10, the first engagement pin 21 is provided at the connection position on the front surface side of the car body 12, and the second engagement pin having a different form from the first engagement pin 21 is provided at the connection position on the rear surface side of the car body 12. However, a blocking member (the first engagement pin 21 or the second engagement pin) may be provided only at anyone of the connection positions on the front surface side and the rear surface side of the car body 12, and an abutment portion capable of abutting against this blocking member may be provided only at one of the front jack arm 16A and the rear jack arm 16B. For example, in a case where the first engagement pin 21 that is a blocking member is provided on the front surface side of the car body 12 but a blocking member is not provided on the rear surface side of the car body 12, and the abutment portion 22 capable of abutting against the first engagement pin 21 is provided only at the rear jack arm 16B, even in a case where the rear jack arm 16B is erroneously attached to the front surface side of the car body 12, the first engagement pin 21 and the abutment portion 22 interfere with each other and cannot be attached. Conversely, in a case where the front jack arm 16A is to be attached to the rear surface side of the car body 12, the attachment is possible. However, in that case, since the rear jack arm 16B cannot be attached to the front surface side of the car body 12, it can be noticed that the attachment position of the front jack arm 16A is incorrect.

Additionally, in the embodiment described above, the front lower weight 17 and the rear lower weight 18 are respectively attached to the car body 12 via the jack arms 16a (front jack arms 16A and rear jack arms 16B) of the jacks 16. However, the front lower weight 17 and the rear lower weight 18 may be directly attached to the car body 12 without using the jacks 16.

In addition, the embodiment of the invention is not limited to the aforementioned embodiment, and various modifications can be made without departing from the scope of the embodiment of the invention, and all technical matters included in the technical idea described in the claims are the subject of the embodiment of the invention. Although the above-mentioned embodiment shows a preferred example, those skilled in the art can realize various alternatives, alternations, modifications, or improvements from the contents disclosed in the present specification. These are included in the technical concept described in the appended claims.

Hereinafter, modification examples of the above embodiment will be described. In addition, a detailed description of the common points with the above embodiment will be omitted, and differences will mainly be described. Additionally, the above-described embodiment and the following modification examples may be carried out not only independently but also may be carried out by combining the embodiment and the modification examples, or the modification examples in any combination.

### Modification Example 1

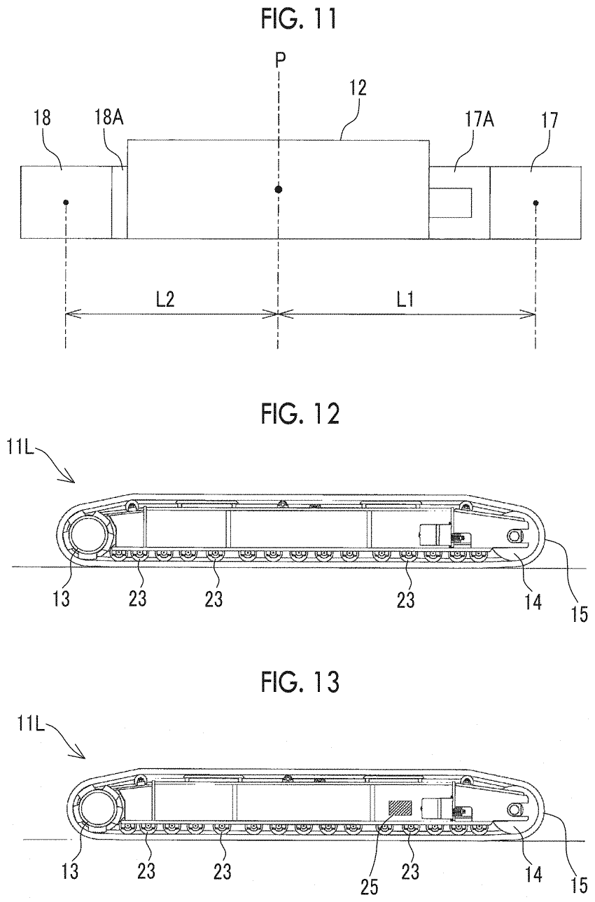

FIG. 11 is an explanatory view illustrating main parts of the crawler-type crane according to Modification Example 1 of the above embodiment. Modification Example 1 is different from the above embodiment in that the front lower weight 17 and the rear lower weight 18 have the same weight (mass), but a distance L1 from the turning center of the upper turning body 3 (illustrated by the straight line P) to the centroid position of the front lower weight 17 and a distance L2 from the turning center of the upper turning body 3 to the centroid position of the rear lower weight 18 are made different from each other.

More specifically, as illustrated in FIG. 11, the front lower weight 17 and the rear lower weight 18 are common members having the same outer size and weight. However, the front lower weight 17 is attached to the front surface side of the car body 12 by using an attachment bracket 17A that is long in the front-rear direction, whereas the rear lower weight 18 is attached to the rear surface side of the car body 12 by using a short attachment bracket 18A. In this way, the distance L1 from the turning center of the upper turning body to the centroid position of the front lower weight 17 is set to be longer than the distance L2 from the turning center to the centroid position of the rear lower weight 18 due to a difference in length between both the attachment brackets 17A and 18A. Therefore, even in a case where the front lower weight 17 and the rear lower weight 18 having the same weight are used, the centroid position of the lower traveling body 1 and the turning center of the upper turning body 3 can be made to substantially coincide with each other.

In addition, in Modification Example 1 illustrated in FIG. 11, a configuration in which the weights of the front lower weight 17 and the rear lower weight 18 are made the same means that the weights of both are designed to be the same, and includes a case where the weights of both are within a range of variation due to a manufacturing error. A case where the weight of a lower weight having a larger difference between the weights of both is less than 5% (for example, 3%) is included in a configuration in which “the weights of the front lower weight 17 and the rear lower weight 18 are the same”. In addition, the weights of the front lower weight 17 and the rear lower weight 18 may be different from each other. For example, in addition to making the distance L1 longer than the distance L2, the centroid position of the lower traveling body 1 may be brought closer to the turning center of the upper turning body 3 by making the weight of the front lower weight 17 heavier than the weight of the rear lower weight 18.

### Modification Example 2

FIG. 12 is a side view of the side frame 11L of the crawler-type crane according to Modification Example 2 of the above embodiment. In Modification Example 2, the centroid position of the lower traveling body 1 may be brought closer to the turning center of the upper turning body 3 by changing the material (weight) of the constituent parts of the side frames 11L and 11R.

As illustrated in FIG. 12, the side frame 11L according to Modification Example 2 supports a plurality of rollers 23 disposed between a drive wheel and the idler 14, in addition to the traveling device 13 including the drive wheel, the idler 14, and the crawler 15. The traveling device 13 transmits a driving force generated by the drive motor to the crawler 15 through the drive wheel. The crawler 15 is rotated by the driving force transmitted through the drive wheel. The idler 14 is driven by the driving force of the traveling device 13 transmitted through the crawler 15.

As previously described, the weight of the traveling device 13 including the drive motor and the speed reducer is heavier than the idler 14. Thus, in Modification Example 2, the weight of the idler 14 is made heavier than the weight of the drive wheel that is the constituent element of the traveling device 13. In addition, the related-art idler 14 is generally formed of cast iron. In contrast, in Modification Example 2, the idler 14 is formed of a metal (for example, forged steel) having a larger specific gravity than cast iron. The same applies to the side frame 11R.

According to Modification Example 2, the centroid position of the lower traveling body 1, which is biased toward the rear end side, can be brought closer to the turning center of the upper turning body 3. Additionally, the weight can be increased without changing the dimensions of the idler 14 by forming the idler 14 of a material having a larger specific gravity than in the past. As a result, the centroid position of the lower traveling body 1 can be brought closer to the turning center of the upper turning body 3 without requiring to change the design of the side frames 11L and 11R.

### Modification Example 3

FIG. 13 is a side view of the side frame 11L of the crawler-type crane according to Modification Example 3 of the above embodiment. In Modification Example 3, the centroid position of the lower traveling body 1 is brought closer to the turning center of the upper turning body 3 by adding new parts to the side frames 11L and 11R.

As illustrated in FIG. 13, the side frame 11L according to Modification Example 3 supports an additional member 25 in addition to the configuration of FIG. 12. More specifically, the additional member 25 is disposed in front of the center of the side frame 11L in the front-rear direction (on a side closer to the idler 14). The additional member 25 may be, for example, apart that is not necessary for performing the operation required for the crawler 15 to travel. Alternatively, the additional member 25 may be a member that functions only as a weight. Moreover, the additional member 25 may be a member that does not support other members.

The additional member 25 according to Modification Example 3 is a rectangular iron plate formed of a metal having a large specific gravity (for example, lead). Additionally, the additional member 25 according to Modification Example 3 is welded to a side surface of the side frame 11L in front of the center of the side frame 11L in the front-rear direction (on the idler 14 side). However, the material, shape, attachment position, and attachment method of the additional member 25 are not limited to the aforementioned example.

In addition, with the traveling device 13, the idler 14, the crawler 15, and the additional member 25 removed, the centroid position of the side frame 11L alone is the same as the turning center of the upper turning body 3 (considered with a manufacturing error of 3%) or is slightly biased to a side on which the traveling device 13 is mounted. Also, as previously described, since the traveling device 13 is heavier than the idler 14, when the traveling device 13, the idler 14, and the crawler 15 are attached to the side frame 11L, the centroid position of the entire lower traveling body 1 is biased to the traveling device 13 side.

Thus, in a case where the additional member 25 is attached to the idler 14 side from the turning center of the upper turning body 3 as in Modification Example 3, the centroid position of the lower traveling body 1 that is biased to the rear end side in the related art can be closer to the turning center of the upper turning body 3. Additionally, by adjusting the center of gravity with the additional member 25 that is not necessary for the operation of the side frames 11L and 11R, the degree of freedom of the shape, size, and attachment position is increased, so that the centroid position can be finely adjusted.

### Modification Example 4

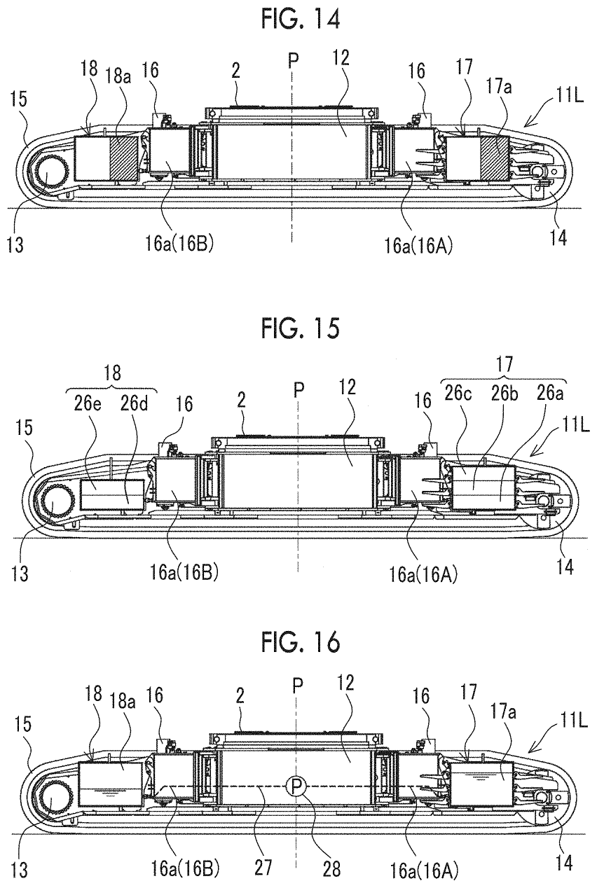

FIG. 14 is a side view illustrating the lower weights 17 and 18 of the crawler crane according to Modification Example 4 of the above embodiment. In Modification Example 4, the centroid position of the lower traveling body 1 is brought closer to the turning center of the upper turning body 3 by unevenly distributing the frame bodies 17a and 18a to be filled with a heavy material in the front-rear direction with the front lower weight 17 and the rear lower weight 18.

As illustrated in FIG. 14, the frame body 17a according to Modification Example 4 is unevenly distributed on the front side of the front lower weight 17 (that is, on a side far from the center of the side frame 11L or 11R in the front-rear direction). Meanwhile, the frame body 18a according to Modification Example 4 is unevenly distributed on the front side of the rear lower weight 18 (that is, on a side close to the center of the side frame 11L or 11R in the front-rear direction). Accordingly, the distance from the turning center of the upper turning body 3 to the centroid position of the front lower weight 17 is longer than the distance from the turning center of the upper turning body 3 to the centroid position of the rear lower weight 18.

According to Modification Example 4, since the rotational moment on the front side is larger than that on the rear side with reference to the center position of the side frame 11L or 11R in the front-rear direction, the centroid position of the lower traveling body 1 can be brought closer to the turning center of the upper turning body 3. In addition, the frame bodies 17a and 18a may be configured to be movable in the front-rear direction inside the front lower weight 17 and the rear lower weight 18. Accordingly, the centroid position of the lower traveling body 1 can be finely adjusted.

### Modification Example 5

FIG. 15 is a side view illustrating the lower weights 17 and 18 of the crawler crane according to Modification Example 5 of the above embodiment. In Modification Example 5, the centroid position of the lower traveling body 1 is brought closer to the turning center of the upper turning body 3 by stacking any number of weights to form the lower weights 17 and 18.

As illustrated in FIG. 15, the front lower weight 17 according to Modification Example 5 is configured by stacking three weights 26a, 26b, and 26c in the up-down direction. Meanwhile, the rear lower weight 18 according to Modification Example 5 is configured by stacking two weights 26d and 26e in the up-down direction. In addition, the weights 26a to 26e may have the same weight or different weights. Moreover, the weights 26a to 26e may be made of the same member or may be made of different members. Additionally, the weights 26a to 26e may be stacked in the front-rear direction, or may be partially stacked in the up-down direction and partially stacked in the front-rear direction.

According to Modification Example 5, the weights of the front lower weight 17 and the rear lower weight 18 can be adjusted by increasing or decreasing the number of the weights 26a to 26e to be stacked. As a result, the centroid position of the lower traveling body 1 can be brought closer to the turning center of the upper turning body 3.

### Modification Example 6

FIG. 16 is a side view illustrating the lower weights 17 and 18 of the crawler crane according to Modification Example 6 of the above embodiment. In Modification Example 6, the centroid position of the lower traveling body 1 can be brought closer to the turning center of the upper turning body 3 by moving a heavy material between the frame bodies 17a and 18a.

As illustrated in FIG. 16, the frame bodies 17a and 18a according to Modification Example 6 are filled with a heavy material having fluidity (for example, water, oil, liquid metal, or the like). Also, the crawler crane according to Modification Example 6 further includes a pipe 27 that connects the frame bodies 17a and 18a to each other, and a pump 28 that sucks up the heavy material filled in one of the frame bodies 17a and 18a and fills it in the other.

According to Modification Example 6, the weights of the front lower weight 17 and the rear lower weight 18 can be adjusted by moving the heavy material between the frame bodies 17a and 18a by the pump 28. As a result, the centroid position of the lower traveling body 1 can be brought closer to the turning center of the upper turning body 3.

In addition, in a case where hydraulic oil for driving the lower traveling body 1, the upper turning body 3, and the drums 8 and 9 (hereinafter referred to as “actuator”) is used as the heavy material, a hydraulic pump (not illustrated) for supplying the hydraulic oil to the actuator may be made to have the function of the pump 28. Meanwhile, when a fluid other than the hydraulic oil is used as the heavy material, the pump 28 needs to be newly provided separately from the hydraulic pump that supplies the hydraulic oil to the actuator.

### Modification Example 7

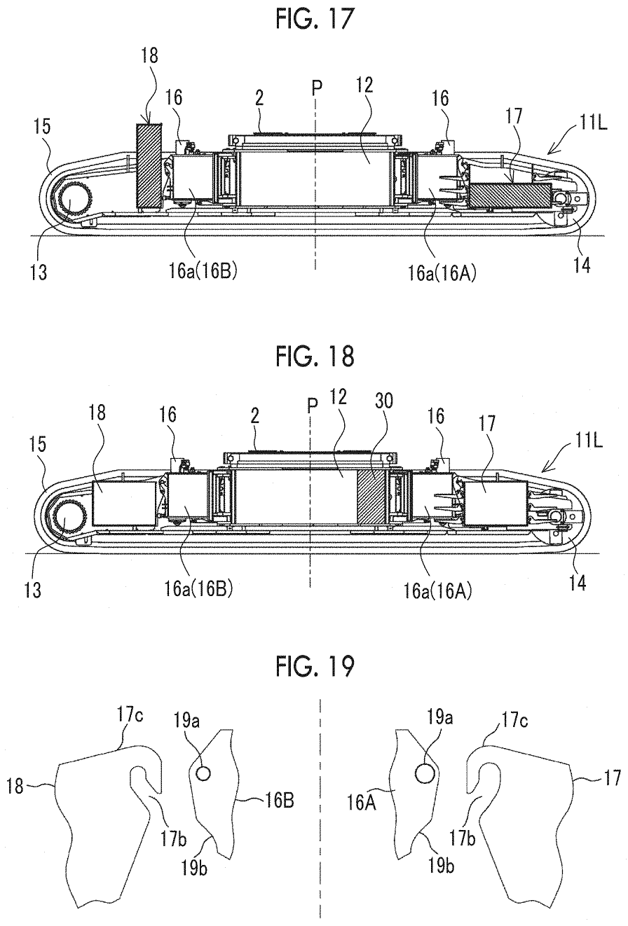

FIG. 17 is a side view illustrating the lower weights 17 and 18 of the crawler crane according to Modification Example 7 of the above embodiment. In Modification Example 7, the centroid position of the lower traveling body 1 is brought closer to the turning center of the upper turning body 3 by changing the attachment direction of the lower weights 17 and 18 having long sides and short sides.

The lower weights 17 and 18 according to Modification Example 7 have a substantially rectangular parallelepiped outer shape. Also, as illustrated in FIG. 17, the front lower weight 17 according to Modification Example 7 is attached to the front jack arm 16A with its long sides oriented in the front-rear direction and its short sides oriented in the up-down direction. Meanwhile, the rear lower weight 18 according to Modification Example 7 is attached to the rear jack arm 16B with its long sides oriented in the up-down direction and its short sides oriented in the front-rear direction. Accordingly, the distance from the turning center of the upper turning body 3 to the centroid position of the front lower weight 17 is longer than the distance from the turning center of the upper turning body 3 to the centroid position of the rear lower weight 18.

According to Modification Example 7, since the rotational moment on the front side is larger than that on the rear side with reference to the center position of the side frame 11L or 11R in the front-rear direction, the centroid position of the lower traveling body 1 can be brought closer to the center of the side frame 11L or 11R in the front-rear direction. In addition, the lower weights 17 and 18 may be configured such that the attachment angle (that is, the orientation of the long sides and the short sides) with respect to the jack arm 16a can be changed. Accordingly, the centroid position of the lower traveling body 1 can be finely adjusted.

### Modification Example 8

FIG. 18 is a side view of the car body 12 of the crawler crane according to Modification Example 8 of the above embodiment. In Modification Example 8, the centroid position of the lower traveling body 1 is brought closer to the turning center of the upper turning body 3 by attaching a weight 30, which is separate from the lower weights 17 and 18, to the car body 12.

As illustrated in FIG. 18, the weight 30 is attached to the car body 12 according to Modification Example 8 in front of the center of the side frame 11L or 11R in the front-rear direction and behind the front lower weight 17.

According to Modification Example 8, the front side of the car body 12 is heavier than that on the rear side. As a result, the centroid position of the lower traveling body 1 can be brought closer to the turning center of the upper turning body 3. In addition, the weight 30 may be a heavy material with which an internal space of the car body 12 is filled, or may be attached to and detached from the outside of the car body 12.

### Modification Example 9

FIG. 19 is a schematic diagram around the attachment portion 17c and the jack arms 16A and 16B according to Modification Example 9 of the above embodiment. In Modification Example 9, an erroneous attachment of the lower weights 17 and 18 is prevented by making the diameters of the pins 19a different from each other between the jack arms 16A and 16B.

As illustrated in FIG. 19, the groove width of the locking groove 17b of the front lower weight 17 according to Modification Example 9 is larger than the groove width of the locking groove 17b of the rear lower weight 18. Additionally, the diameter of the pin 19a of the front jack arm 16A according to Modification Example 9 is larger than the diameter of the pin 19a of the rear jack arm 16B. In addition, the groove widths of the locking groove 17b and the diameter of the pin 19a may be different from each other on the front and rear, and the magnitude relationship may be opposite to that in the aforementioned example.

According to Modification Example 9, the front lower weight 17 can be attached to both the jack arms 16A and 16B, but the rear lower weight 18 can be attached only to the rear jack arm 16B. That is, the front jack arm 16A is configured such that the front lower weight 17 can be attached thereto and the rear lower weight 18 cannot be attached thereto. For that reason, even in a case where the front lower weight 17 is erroneously attached to the rear jack arm 16B, an erroneous attachment can be noticed when the rear lower weight 18 is attached to the front jack arm 16A.

### Modification Example 10

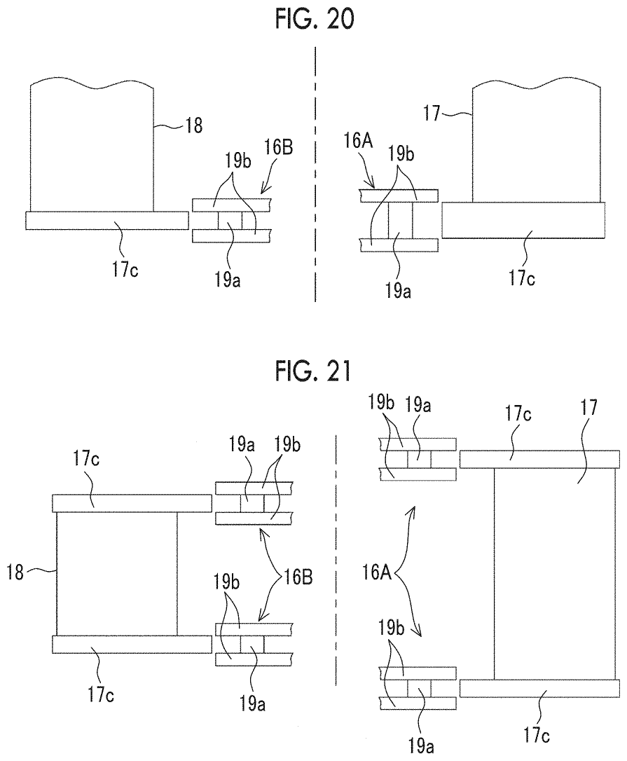

FIG. 20 is a schematic diagram around the attachment portion 17c and the jack arms 16A and 16B according to Modification Example 10 of the above embodiment. In Modification Example 10, an erroneous attachment of the lower weights 17 and 18 is prevented by making the distance between holding plates for holding the pin 19a different between the jack arms 16A and 16B.

As illustrated in FIG. 20, the plate thickness (dimension in the right-left direction) of the attachment portion 17c of the front lower weight 17 according to Modification Example 10 is larger than the plate thickness of the attachment portion 17c of the rear lower weight 18. Additionally, in the attachment receiving portion 19b of the front jack arm 16A according to Modification Example 10, the distance between holding plates that hold both ends of the pin 19a is larger than that of the attachment receiving portion 19b of the rear jack arm 16B. In addition, the plate thickness of the attachment portions 17c and 18c and the distance between the holding plates may be different on the front and rear, and the magnitude relationship may be opposite to the aforementioned example.

According to Modification Example 10, the rear lower weight 18 can be attached to both the jack arms 16A and 16B, but the front lower weight 17 can be attached only to the front jack arm 16A. That is, the rear jack arm 16B is configured such that the rear lower weight 18 can be attached thereto and the front lower weight 17 cannot be attached thereto. For that reason, even in a case where the rear lower weight 18 is erroneously attached to the front jack arm 16A, an erroneous attachment can be noticed when the front lower weight 17 is attached to the rear jack arm 16B.

### Modification Example 11

FIG. 21 is a schematic diagram around the attachment portion 17c and the jack arms 16A and 16B according to Modification Example 11 of the above embodiment. In Modification Example 11, an erroneous attachment of the lower weights 17 and 18 is prevented by making the distance between a pair of attachment receiving portions 19b different between the jack arms 16A and 16B.

As illustrated in FIG. 21, the distance between the pair of left and right attachment portions 17c of the front lower weight 17 according to Modification Example 11 is larger than the distance between the pair of left and right attachment portions 17c of the rear lower weight 18. Additionally, the distance between the pair of left and right attachment receiving portions 19b of the front jack arm 16A according to Modification Example 11 is larger than the distance between the pair of left and right attachment receiving portions 19b of the rear jack arm 16B. In addition, the distance between the attachment portions 17c and the distance between the attachment receiving portions 19b may be different on the front and rear, and the magnitude relationship may be opposite to the aforementioned example.

That is, the front jack arm 16A is configured such that the front lower weight 17 can be attached thereto and the rear lower weight 18 cannot be attached thereto. Additionally, the rear jack arm 16B is configured such that the rear lower weight 18 can be attached thereto and the front lower weight 17 cannot be attached thereto.

According to Modification Example 11, the front lower weight 17 can be attached only to the front jack arm 16A, and the rear lower weight 18 can be attached only to the rear jack arm 16B. For that reason, an erroneous attachment of the lower weights 17 and 18 can be quickly noticed.

### Modification Example 12

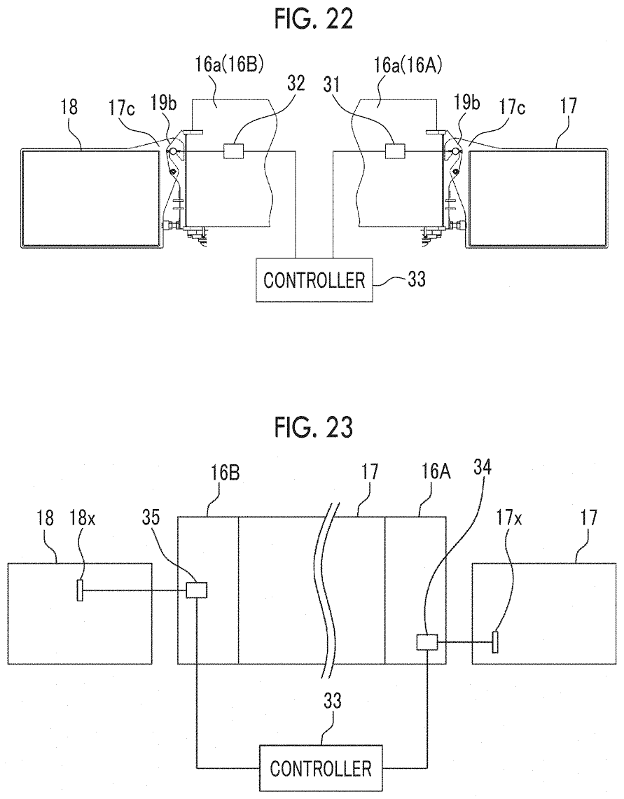

FIG. 22 is a view illustrating the jack arms 16A and 16B and the lower weights 17 and 18 according to Modification Example 12 of the above embodiment. In Modification Example 12, an erroneous attachment of the lower weights 17 and 18 is prevented by measuring the physical quantity (for example, weight, pressure, or the like) when the lower weights 17 and 18 are attached to the jack arms 16A, 16B.

As illustrated in FIG. 22, the crawler crane according to Modification Example 12 includes a sensor 31 that measures a physical quantity added to the pin 19a of the front jack arm 16A, a sensor 32 that measures a physical quantity added to the pin 19a of the rear jack arm 16B, and a controller 33 that determines whether or not the correct lower weights 17 and 18 are attached to the jack arms 16A and 16B on the basis of signals output from the sensors 31 and 32.

The controller 33 includes, for example, a ROM that stores a program, a CPU that reads and executes the program stored in the ROM, and a RAM that serves as a work area when the CPU executes the program. Also, the ROM or RAM stores the range of physical quantities added to the pins 19a when the lower weights 17 and 18 are attached.

The controller 33 determines whether or not the physical quantity measured by the sensor 31 is within the range of the physical quantity corresponding to the front lower weight 17. Then, in a case where the physical quantity measured by the sensor 31 is within the range of the physical quantity corresponding to the front lower weight 17, the controller 33 determines that the correct front lower weight 17 is attached to the front jack arm 16A. On the other hand, in a case where the physical quantity measured by the sensor 31 is out of the range of the physical quantity corresponding to the front lower weight 17, the controller 33 determines that a wrong weight (for example, the rear lower weight 18) is attached to the front jack arm 16A.

Then, the controller 33 notifies an operator of the aforementioned determination result through a notification device (for example, a display, a speaker, an LED lamp, or the like) installed in the cab 4. In addition, the same applies to a method of determining whether or not the rear lower weight 18 is attached to the rear jack arm 16B on the basis of the physical quantity measured by the sensor 32.

As an example of the physical quantity, in a case where the load applied to the pin 19a is measured, load cells may be the sensors 31 and 32. As another example of the physical quantity, in a case where the pressure applied to the pin 19a is measured, pressure sensors may be the sensors 31 and 32. Also in a case where other physical quantities are measured, the sensors 31 and 32 suitable for the measured physical quantities may be used.

According to Modification Example 12, the controller 33 determines whether or not the correct lower weights 17 and 18 are attached to the jack arms 16A and 16B. Thus, even in a case where the operator who performs the attachment work does not notice, the crawler crane can be prevented from operating with an erroneous attachment.

That is, the controller 33 and the sensors 31, 32 according to Modification Example 12 are examples of detection units that detect whether or not the lower weights 17 and 18 are attached to the car body 12 at correct positions. However, one of the sensors 31 and 32 can be omitted.

### Modification Example 13

FIG. 23 is a view illustrating the jack arms 16A and 16B and the lower weights 17 and 18 according to Modification Example 13 of the above embodiment. In Modification Example 13, an erroneous attachment of the lower weights 17 and 18 is prevented by limit switches 34 and 35 that respond only to the correct combination of the jack arms 16A and 16B and the lower weights 17 and 18.

In the example of FIG. 23, the limit switches 34 and 35 and target members 17x and 18x are attached to both front and rear sides, but the limit switches and the target members may not be attached to both front and rear sides. For example, only the front jack arm 16A may include the limit switch 34, and only the front lower weight 17 may include the target member 17x. Accordingly, in a case where the lower weight is attached in the correct combination, the limit switch operates. On the other hand, in a case where the combination is wrong, the limit switch does not operate because there is no target member. This may prevent an erroneous attachment. In the case of such a configuration, it is possible to reduce the number of limit switches and target members, which results in cost saving.

As illustrated in FIG. 23, the crawler crane according to Modification Example 13 includes the controller 33, the limit switch 34 provided on the front jack arm 16A, and the limit switch 35 provided on the rear jack arm 16B. The configuration of the controller 33 may be the same as that of Modification Example 12.

The limit switches 34 and 35 are attached to the jack arms 16A and 16B at different positions in the front-rear direction. Additionally, although not illustrated, the limit switches 34 and 35 may be attached to the jack arms 16A and 16B at different positions in the right-left direction.

Additionally, when the lower weights 17 and 18 are attached to the jack arms 16A and 16B, the target members 17x and 18x that abut against the limit switches 34 and 35 are attached to the lower weights 17 and 18 at the positions corresponding to the limit switches 34 and 35.

For that reason, when the front lower weight 17 is attached to the front jack arm 16A, the limit switch 34 abuts against the target member 17x, and a signal is output to the controller 33. Meanwhile, when the rear lower weight 18 is attached to the front jack arm 16A, the limit switch 34 does not abut against the target member 18x, and no signal is output to the controller 33.

Then, in a case where a signal is output from the limit switch 34, the controller 33 determines that the correct front lower weight 17 is attached to the front jack arm 16A. On the other hand, when no signal is output from the limit switch 34, the controller 33 determines that no correct front lower weight 17 is attached to the front jack arm 16A.

Then, the controller 33 notifies an operator of the aforementioned determination result through a notification device (for example, a display, a speaker, an LED lamp, or the like) installed in the cab 4. In addition, the same applies to a method for determining whether or not the rear lower weight 18 is attached to the rear jack arm 16B on the basis of the signal from the limit switch 35.

According to Modification Example 13, the controller 33 determines whether or not the correct lower weights 17 and 18 are attached to the jack arms 16A and 16B. Thus, even in a case where the operator who performs the attachment work does not notice, the crawler crane can be prevented from operating with an erroneous attachment.

That is, the controller 33, the limit switches 34 and 35, and the target members 17x and 18x according to Modification Example 13 are examples of detection units that detect whether or not the lower weights 17 and 18 are attached to the car body 12 at correct positions. However, one of the limit switches 34 and 35 can be omitted. The same applies to the target members 17x and 18x.

It should be understood that the invention is not limited to the above-described embodiment, but may be modified into various forms on the basis of the spirit of the invention. Additionally, the modifications are included in the scope of the invention.

What is claimed is:

1. A crawler-type crane comprising:
an upper turning body; and
a lower traveling body on which the upper turning body is turnably mounted and which has a pair of left and right side frames, a car body that connects both the side frames to each other to support the upper turning body, and a front lower weight and a rear lower weight attached to both front and rear end sides of the car body,
wherein rotational moments with reference to the center position of the upper turning body of the front lower weight and the rear lower weight are made different from each other.

2. The crawler-type crane according to claim 1,
wherein weights of the front lower weight and the rear lower weight are made different from each other.

3. The crawler-type crane according to claim 2,
wherein outer shapes of frame bodies that form outer shells of the front lower weight and the rear lower weight are the same, and weights of filling materials with which insides of both the frame bodies are filled are different from each other.

4. The crawler-type crane according to claim 2,
wherein the front lower weight and the rear lower weight are attached to the car body via attachment mechanisms having different connection forms.

5. The crawler-type crane according to claim 4,
wherein a body-side pin is provided on any one of both front and rear end portions of the car body and a body-side hook is provided on the other thereof, a weight-side hook that engages with the body-side pin is provided on any one of the front lower weight and the rear lower weight, and a weight-side pin that engages with the body-side hook is provided on the other thereof.

6. The crawler-type crane according to claim 2,
wherein the lower traveling body includes jacks at both front and rear end portions of the car body, respectively, the front lower weight is attached to the front jack, and the rear lower weight is attached to the rear jack.

7. The crawler-type crane according to claim 2, further comprising:
a detection unit that detects whether or not the front lower weight or the rear lower weight is attached to a correct position of the car body.

8. The crawler-type crane according to claim 6,
wherein the front jack and the rear jack are attached to the car body via attachment mechanisms having different connection forms.

9. The crawler-type crane according to claim 4,
wherein at least one of a front end side and a rear end side of the car body is configured such that one of the front lower weight and the rear lower weight is attachable thereto and the other is not attachable thereto.

10. The crawler-type crane according to claim 9,
wherein at least one of the front end side and the rear end side of the car body is provided with a blocking member that allows attachment of any one of the front lower weight and the rear lower weight to block attachment of the other.

11. The crawler-type crane according to claim 2,
wherein the side frame has an idler and a traveling device disposed at both end portions in a front-rear direction, and a crawler mounted on outer peripheries of the idler and the traveling device, the front lower weight is attached to a front end side of the car body close to the idler, and the rear lower weight is attached to a rear end side of the car body close to the traveling device.

12. The crawler-type crane according to claim 1,
wherein a distance from a turning center of the upper turning body to a centroid position of the front lower weight and a distance from the turning center of the upper turning body to a centroid position of the rear lower weight are made different from each other.

13. The crawler-type crane according to claim 12,
wherein the front lower weight and the rear lower weight have the same weight.

14. A crawler-type crane comprising:
an upper turning body; and
a lower traveling body on which the upper traveling body is turnably mounted and which has a pair of left and right side frames and a car body that connects both the side frames to each other to support the upper turning body,
wherein the side frame supports
a traveling device that is disposed on one end side in a front-rear direction and generates a driving force,
an idler that is disposed on the other end side in the front-rear direction and is driven by the driving force of the traveling device being transmitted thereto,
a crawler that is mounted on outer peripheries of the idler and the traveling device and that rotates by the driving force of the traveling device being transmitted thereto, and
an additional member, and
wherein the additional member is attached to the side frame on a side closer to the idler than a turning center of the upper turning body.

15. A crawler-type crane comprising:
an upper turning body; and
a lower traveling body on which the upper traveling body is turnably mounted and which has a pair of left and right side frames and a car body that connects both the side frames to each other to support the upper turning body,
wherein the side frame supports
a traveling device that is disposed on one end side in a front-rear direction and generates a driving force,
an idler that is disposed on the other end side in the front-rear direction and is driven by the driving force of the traveling device being transmitted thereto, and
a crawler that is mounted on outer peripheries of the idler and the traveling device and that rotates by the driving force of the traveling device being transmitted thereto,
wherein the traveling device has a drive wheel that transmits the driving force to the crawler, and
wherein a weight of the idler is heavier than a weight of the drive wheel.
